(19) United States
(12) Patent Application Publication
(10) Pub. No.: US 2026/0103208 A1
(43) Pub. Date: Apr. 16, 2026

(54) METHOD AND SYSTEM INFORMING ON HOMEBASE

(71) Applicant: International Truck Intellectual Property Company, LLC, Lisle, IL (US)

(72) Inventor: Eric Michael Dluzen, Aurora, IL (US)

(73) Assignee: International Truck Intellectual Property Company, LLC, Lisle, IL (US)

(21) Appl. No.: 18/828,613

(22) Filed: Sep. 9, 2024

(51) Int. Cl. B60W 50/14; B60W 50/00; H04W 4/38; H04W 4/44

(52) U.S. Cl. CPC B60W 50/14; B60W 50/0098; H04W 4/38; H04W 4/44; B60W 2050/0083; B60W 2556/45

(57) ABSTRACT

A method and system for informing on a homebase are provided. In some aspects, a method includes receiving homebase data corresponding to a homebase at a homebase location, wherein the homebase data is transmitted over a communication network to a vehicle at a remote location. The method also includes generating, using an ambient control module, at least one ambient control signal using the homebase data, and informing a vehicle operator on the homebase by operating at least one sensory device inside the vehicle using the at least one ambient control signal.

### FIELD

The present disclosure generally relates to vehicle technologies. More particularly, the present disclosure relates to systems and methods informing on a homebase.

### BACKGROUND

A vehicle operator, such as a truck driver, can sometimes spend an appreciable amount of time on a long-haul trip. Based on company protocols as well as safety concerns, the truck driver may be unable to or prohibited from getting in contact with family and friends at home, for example, via cell phone. As a result, the truck driver can feel anxiety, loneliness, disconnection, and so forth. In addition, the truck driver may miss important events, such as medical emergencies, weather changes, and so forth happening at home.

Therefore, there is a need for improved vehicle technologies that can implement connectedness and convenience for drivers.

### SUMMARY

A method for informing on a homebase is provided. In one embodiment, the method includes steps for receiving homebase data corresponding to a homebase at a homebase location, wherein the homebase data is transmitted over a communication network to a vehicle at a remote location. The method also includes steps for generating, using an ambient control module, at least one ambient control signal using the homebase data, and informing a vehicle operator of the vehicle on the homebase by operating at least one sensory device inside the vehicle using the at least one ambient control signal.

A system for informing on a homebase is provided. In one embodiment, the system includes at least one sensory device disposed inside a vehicle and at least one processor in communication with the at least one sensory device. The at least one processor receives homebase data acquired by at least one device of a homebase at a homebase location, and generates one or more ambient control signal using the homebase data. The at least one processor also informs on the homebase by operating at least one sensory device inside the vehicle using the at least one ambient control signal.

### BRIEF DESCRIPTION OF THE DRAWINGS

The present disclosure describes various embodiments with reference to the accompanying figures, wherein like reference numerals denote like elements. The embodiments described are presented by way of example, and not by way of limitation, in the accompanying drawings:

FIG. 1 is a diagram of an example system, as described herein;

FIG. 2 is a graphical illustration of another example system, as described herein;

FIG. 3 is a diagram of another example system, as described herein; and

FIG. 4 is a flowchart setting forth steps of a process, as embodiments herein.

### DETAILED DESCRIPTION

Retaining connectivity in a vehicle while maintaining safety can be challenging with vehicle traditional technologies. Therefore, the present disclosure provides a technical solution for informing on a homebase. As appreciated from description below, the present approach provides a number of benefits and improves a number of technologies, such as vehicle technologies. For example, the present approach may enable a driver of a vehicle to safely connect with family members at the homebase when working by way of controlling or adapting an environment inside the vehicle. Also, the present approach may inform a driver regarding a condition (e.g., an emergency) occurring at the homebase. In this manner, the driver may be able to take appropriate action, such as stopping or finding a location to make a call with no risk to safety. The driver may also maintain focus and safety on the road, with less trivial distractions.

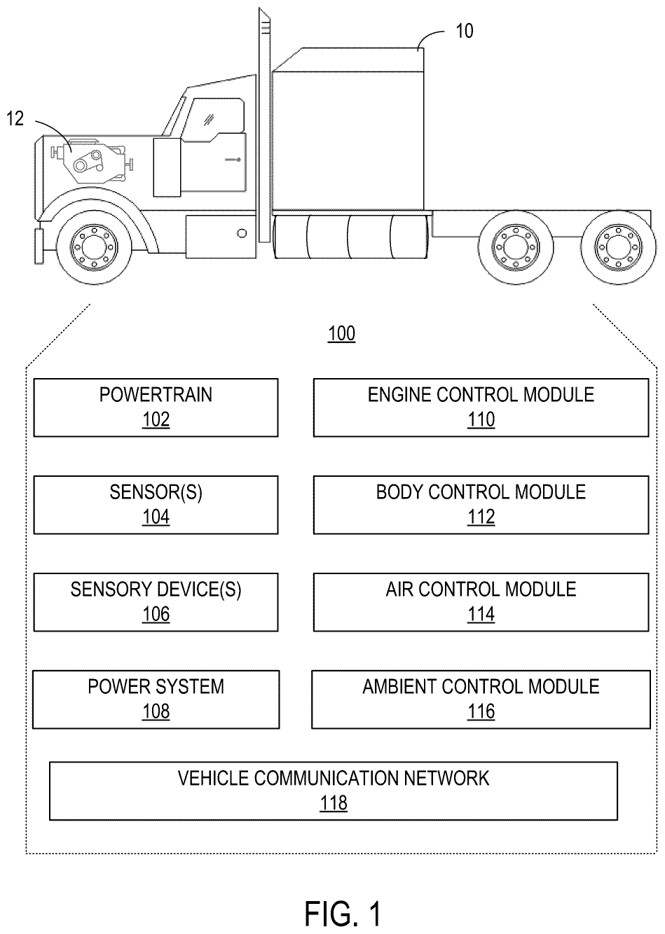

FIG. 1 illustrates an example vehicle system 100, in accordance with aspects of the present disclosure. In some embodiments, the vehicle system 100 may be part of, or incorporated into, a vehicle 10, as shown in FIG. 1. While FIG. 1 shows a specific example of a vehicle 10, the vehicle 10 may include any type of automobile, truck, trailer tractor, utility vehicle, sport utility vehicle (SUV), recreational vehicle (RV), all-terrain vehicle (ATV), as well as boat, plane, drone, train, motor driven cycle, bicycle, and any other machine for transporting goods and/or people.

In general, the system vehicle 100 may include a vehicle powertrain 102, one or more sensor 104, one or more sensory device 106, and a power system 108. The powertrain 104 may include a variety of components, including a vehicle engine 12, transmission, driveshaft, axle, differential, and so forth, that together create power and deliver it to wheels of the vehicle 10 to propel the vehicle 10. In some applications, the vehicle 10 is powered by an internal combustion engine. In other applications, the vehicle 10 is powered by electric power provided by one or more electric motors. In yet other applications, the vehicle 10 is powered by a combination of electric and combustion power. In yet other applications, the vehicle 10 is powered by hydrogen, propane, natural gas, and any other form of vehicle propulsion.

The sensor(s) 104 may include a variety of sensors and sensing devices that can provide data, signals, and information about the vehicle 10 and/or vehicle engine 12 operation. For example, the sensors 104 may include one or more steering angle sensor, yaw rate sensor, brake pressure sensor, grade sensor, inclinometer sensor, wheel sensor, speed sensor, cruise control sensor, transmission gear sensor, load sensor, fuel sensor, airflow sensor, coolant sensor, sparkplug sensor, throttle sensor, oxygen sensor, temperature sensor, pressure sensor, voltage sensor, current sensor, and so forth.

The sensory device(s) 106 may include a variety of hardware, devices, components disposed inside or about the vehicle 10 that can, among other functions, provide various data, signals, and information about a homebase by way of sensory stimulation. In some embodiments, the sensory device(s) 106 may be responsive to one or more ambient control signal generated and provided thereto, in accordance with aspects of the present disclosure. For example, the sensory device(s) 106 may include one or more audiovisual device, such as a light, LED, button, speaker, display, touchscreen, and so forth, that can provide audio and/or visual stimulation to a vehicle operator. In other non-limiting examples, the sensory device(s) 106 may include one or more haptic device that can provide force, vibration, and/or motion stimulation to a vehicle operator. In yet other non-limiting examples, the sensory device(s) 106 may include one or more scent dispenser that may provide scent stimulation to a vehicle operator. In some embodiments, one or more sensory device 106 may operate independently, for instance, as a standalone device, or may cooperate with, or may be incorporated into, another component, device, and/or system on the vehicle 10.

The power system 108 may include a variety of hardware and components, including one or more batteries, solar panels, starters, alternators, relays, converters, controllers, regulators, switches, solenoids, electrical wiring, electrical circuitry, electrical elements, and so forth. In some embodiments, the power system 108 provides power to one or more sensors 104 and/or sensory device(s) 106 on the vehicle 10.

Referring again to FIG. 1, the system vehicle 100 may also include a number of control modules that perform, manage, and monitor various functions of the vehicle 10. For instance, in some embodiments, the vehicle system 100 may include an engine control module (ECM) 110, a body control module (BCM) 112, an air control module 114, and an ambient control module 116.

The ECM 110 may control various parameters and functions of the engine 12 of the vehicle 10, including the air-fuel ratio, idle speed, valve timing, ignition timing, crankshaft position, and so forth. To this end, the ECM 110 may include any combination of analog and/or digital inputs and outputs, microprocessors, integrated circuitry, memories, clocks, Application Programming Interfaces (APIs), firmware, software, and so forth, and may communicate with various sensors 104, actuators 106, and other components on the vehicle 10.

The BCM 112 may monitor and control various vehicle body, security, and convenience functions. For instance, the BCM 112 may manage exterior lighting, interior lighting, car locking, remote entry, remote start, windshield wipers, seat adjustment, tire pressure monitoring, and so forth. To this end, the BCM 112 may include various hardware, such as analog and/or digital input and output, processor, microprocessor, integrated circuitry, programmable circuitry, clock, battery, API, and so forth, and may communicate with, monitor various components on the vehicle 10.

The air control module 114 may monitor and control various functions and components associated with air flow in the vehicle 10. For instance, in some embodiments, the air control module 114 may control air flow and/or temperature inside or flowing into the vehicle 10 by operating various air control components, such as a fan, a compressor, a turbo, a valve, a heater, and so forth.

The ambient control module 116 may monitor and control various functions and components associated with an ambient environment inside the vehicle 10. To this end, the ambient control module 116 may include various hardware, such as analog and/or digital input and output, processor, microprocessor, integrated circuitry, programmable circuitry, clock, battery, API, and so forth, and may communicate with, monitor various components on the vehicle 10. In some embodiments, the ambient control module 116 may include a memory or a non-transitory computer-readable storage medium for storing and retrieving data, information, and executable instructions. The ambient control module 116 may operate independently, as well as receive instructions from, or cooperate with, various external computers, systems, or devices, including other components on the vehicle 10.

In some embodiments, the ambient control module 116 may carry out steps in accordance with methods of the present disclosure. For instance, the ambient control module 116 may receive, access, and/or process homebase data, and generate at least one ambient control signal based on the homebase data. The ambient control module 116 may then carry out one or more steps to operate one or more sensor device 106 inside the vehicle 10. In some implementations, the ambient control module 116 may generate a sensory pattern indicative of at least one condition of a homebase at a homebase location. For example, the sensory pattern may indicate a light condition, a temperature condition, a ventilation condition, a scent condition, an emergency condition, a weather condition, a time, a date, and so forth, at the homebase. In some implementations, the ambient control signal(s) may adapt an environment in the vehicle 10, by virtue of the one or more sensory device 106. In this manner, the ambient control module 116 may inform a vehicle operator of the vehicle 10 on a condition of the homebase, as well as provide various information regarding the homebase in a safe and/or convenient manner.

The ambient control module 116 may also generate and provide a report. The report may be in any form, and include various data and information, including various visual and/or audio signals, images, graphics, tabulated information, data, instructions (user-readable or machine-readable), graphs, lists, numbers, text, and so forth. For example, the report may indicate a condition at the homebase. The report may be communicated to one or more users by way of a display, touchscreen, navigation system, speaker, and other outputs on the vehicle 10, as well as transmitted to various devices, systems, or third parties. For example, the report may be streamed, printed, faxed, emailed, and so forth, as well as communicated using telematics, over-the-air transmission, datalink (e.g., J1939), and other communication protocols. In some embodiments, the ambient control module 116 may generate and transmit the report in cooperation with various communication hardware in the vehicle communication network 118. The report may be provided in real-time, intermittently, periodically (e.g., hourly, daily, weekly, monthly, and so forth), or any combination thereof. The report may also be saved in a storage medium (e.g., a memory, a database, a server, etc.) for later access or retrieval.

Components of the vehicle system 100 may be operatively coupled, connectable, or connected to one another, and exchange signals, data, and information, by way of a vehicle communication network 118. The vehicle communication network 118 may include a variety of hardware and components that provide wired and wireless connectivity via various communication protocols. Non-limiting examples of communication protocols include Control Area Network (CAN), Local Interconnect Network (LIN), Flex-Ray, Vehicle Area Network (VAN), Media Oriented System Transport (MOST), Bluetooth™, Wi-Fi, and so forth. In some embodiments, the vehicle communication network 118 may include one or more vehicle bus that interconnect components and hardware in the vehicle system 100. The communications network 118 may also include various gateways, bridges, receivers, transmitters, transceivers, antennas, and other components, circuitry and hardware that enable or facilitate communication.

Although specific components are shown and described with reference to FIG. 1, the vehicle system 100 may include more or fewer components. For instance, in some embodiments, the vehicle system 100 may include various hardware to perform various tasks on the vehicle 10, including regulating fluid flow, moving, or energizing components, controlling valves, activating switches, operating gears, and so forth, by way of hydraulic, pneumatic, magnetic, or electrical activation or movement of components. Also, in some embodiments, the vehicle system 100 may include a number of input/output (I/O) modules or components, such as buttons, dials, knobs, touchscreens, keyboards, monitors, screens, panels, displays, buzzers, speakers, and so forth, that can receive instructions or input from a user, and provide data, information, instructions, and other outputs to a vehicle operator. In addition, in some embodiments, the vehicle system 100 may include modules for brake control, climate control, transmission control, and so on.

Furthermore, the system vehicle 100 may integrate or separate tasks, as described. For instance, in some embodiments, the ambient control module 116 be incorporated into, replaced by, or cooperate with the BCM 112 to carry out steps as described, such as informing a vehicle operator on a condition of the homebase, or providing information regarding the homebase by virtue of one or more sensor device 106 in the vehicle 10. In other embodiments, the ambient control module 116 be incorporated into, replaced by, or cooperate with a navigation system of the vehicle 10. In yet other embodiments, in some embodiments, the ambient control module 116 be incorporated into, replaced by, or cooperate with a personal device (e.g., smartphone, laptop, tablet, and so forth).

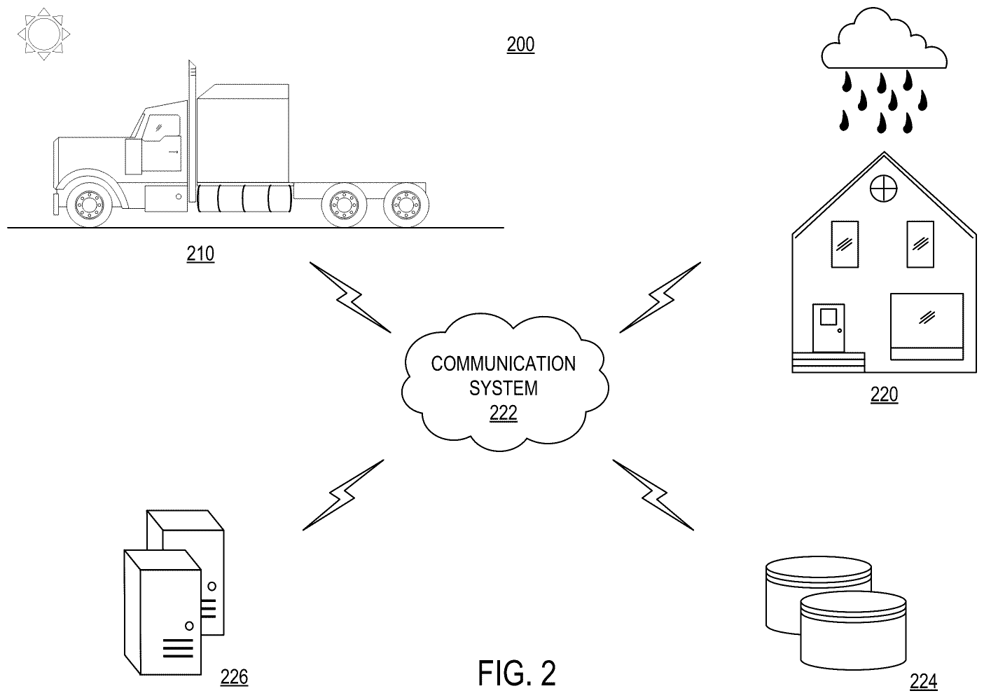

Turning now to FIG. 2, an example system 200 is illustrated, in accordance with aspects of the present disclosure. In some embodiments, the system 200 may include a vehicle 210, and a homebase 220, where the homebase 220 may be situated at a homebase location, while the vehicle 210 may be situated at a remote location. As illustrated in the example of FIG. 2, the homebase location and remote location may experience different situations, such as different weather conditions, different accessibilities (e.g., network, etc.), and so forth.

The vehicle 210 and homebase 200 may be connected to a communication network via a communication system 222, which may include any number of network connections, either wired, wireless, or a combination of both. In some embodiments, the communication system 226 may include proprietary or dedicated communication networks, as well as open networks, such as the internet or cloud-based networks. To this end, the communication system 226 may include or utilize various hardware, components, device, and infrastructure capable of utilizing CAN, LIN, VAN, Flex-Ray, MOST, Bluetooth™, Wi-Fi, and other communication protocols.

While FIG. 2 shows an example illustration of a homebase 220, the homebase 220 may include a variety of residential and/or commercial properties or establishments. For instance, in one non-limiting example, the homebase 220 may include a home. In another non-limiting example, the homebase 220 may include an office, worksite, headquarters, and so forth. As described, the homebase 220 may include a variety of capabilities for generating and providing homebase data. For instance, the homebase 220 may include various sensors, devices, and/or hardware capable of capturing and storing various quantitative and/or qualitative data, signals, and information, indicative of various conditions at the homebase 220, such as a light condition (e.g., configuration, status, and/or setting of one or more light device), a temperature (e.g., ambient temperature) condition, a pressure condition (e.g., ambient pressure), a ventilation condition (e.g., configuration, status, and/or setting of one or more ventilator, A/C unit, humidifier, etc.), a scent condition (e.g., configuration, status, and/or setting of one or more volatile dispenser, etc.), an emergency condition (e.g., fire, intruder, flood, earthquake etc.), a weather condition (e.g., sunshine, rain, storm, hail, snow, wind, tornado, and so forth), a time, a date, and so forth. To this end, various sensors, devices, and/or hardware of the homebase 220 may be connected or are connectable to the communication system 222 and capable of transmitting, and/or providing access to, various data and information acquired or stored therein.

In some embodiments, the system 200 may include one or more database 224 as well as one or more server 226 that may be connected or connectable to the vehicle 210 and/or homebase 220 via the communication system 222. The database(s) 224 and/or server(s) 226 may provide various capabilities, including storage and/or processing capabilities for data, signals, and information associated with the homebase 220. For instance, in one non-limiting example, the server(s) 226 may store and provide access to weather-related data corresponding to the homebase location.

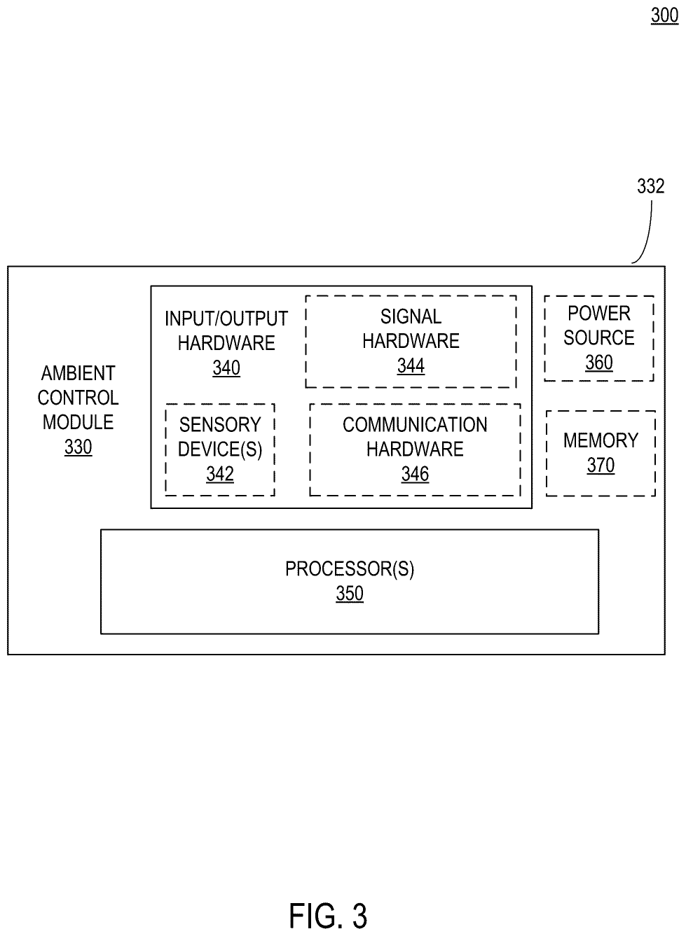

Turning now to FIG. 3, an example system 300, in accordance with aspects of the present disclosure, is provided. The system 300 may generally include an ambient control module 330 with a housing 332 that may include various I/O hardware 340 and one or more processor 350. In some embodiments, the system 300 may optionally include a power source 360 and a memory 370.

The I/O hardware 340 may include various input and output elements that can receive, transmit, and provide various data, signals, information, and instructions. In some embodiments, the I/O hardware 340 may include one or more sensory device 342 responsive to one or more ambient control signal generated and provided thereto, in accordance with aspects of the present disclosure. For example, the sensory device(s) may include one or more sensory device, such as a light, LED, button, speaker, display, touchscreen, and so forth, that can provide audio and/or visual stimulation to a vehicle operator. In other non-limiting examples, the sensory device(s) may include one or more haptic device that can provide force, vibration, and/or motion stimulation to a vehicle operator. In yet other non-limiting examples, the sensory device(s) may include one or more scent dispenser that may provide scent stimulation to a vehicle operator. In some implementations, the I/O hardware 340 may provide a report indicative of a condition at a homebase, and so forth.

Although FIG. 3 shows the sensory device(s) 342 contained in the housing 332 of the ambient control module 330, in some embodiments, one or more sensory device 342 may be external to the housing 332. For instance, one or more sensory device 342 may be associated with, or part of, a dashboard, a navigation system, a head-up display, a console, a readout, and so forth, on a machine, a vehicle, or any other type of equipment, and connected or connectable to the ambient control module 330 via I/O hardware 340. In some embodiments, one or more sensory device 342 may operate independently, for instance, as a standalone device, as well as receive instructions from, or cooperate with, various external computers, systems, or devices, including other components on a vehicle.

In some embodiments, as illustrated in FIG. 3, the I/O hardware 340 may include various signal hardware 344 that can acquire, sample, transform, receive, transmit, process, and/or generate various signals, data, and information. Non-limiting examples include data loggers, recorders, signal converters (e.g., analog-to-digital, digital-to-analog, voltage, frequency, voltage-to-frequency, frequency-to-voltage, current-to-voltage, voltage-to-current etc.), signal conditioners (e.g., amplifiers, attenuators, filters, inverters, choppers, etc.), signal generators, relays, busses, switches, circuitry, interfaces, boards, clocks, and so forth.

In some embodiments, the I/O hardware 340 may include various communication hardware 246 that can facilitate communication of signals, data, and information between components of the ambient control module 330, as well as between the ambient control module 330, and components therein, and external sensors, devices, modules, systems, and so forth. Non-limiting examples include connectors, ports, circuitry, adapters, interface cards, network cards, busses, circuitry, transmitters, receivers, transceivers, antennas, modulators, modes, and so forth.

The processor(s) 350 may carry out a variety of steps for operating the system 300, such as accessing, processing, receiving, transmitting, and/or storing various signals, data, and information. To do so, the processor(s) 350 may include or utilize one or more programmable processors that can execute instructions or sequences of instructions. Such communicated to the processor(s) 350, or accessed by the processor(s) 350 from, for instance, a memory, database, or other data storage location(s). Alternatively, or additionally, the processor(s) 350 may include one or more dedicated processors, processing units, devices, modules, or systems specifically configured to (e.g., hardwired, or pre-programmed) carry out such tasks and steps. By way of example, the processor(s) 350 may include any combination of central processing units (CPUs), graphics processing units (GPUs), Digital Signal Processing (DSP) chips, Application Specific Integrated Circuits (ASICs), Field Programmable Gate Arrays (FPGAs), microprocessors, integrated circuitry, programmable circuitry, and so forth.

As illustrated in FIG. 3, the ambient control module 330 may optionally include a power source 360 (e.g., a battery) inside the housing 332 to power various components of the ambient control module 330. Additionally, or alternatively, the ambient control module 330 may connected to and receive external power from an external source, such as a vehicle 10, as described with reference to FIG. 1. In some embodiments, the power source 360 may include various hardware for adapting, storing, and/or delivering power to various components in the ambient control module 330.

The ambient control module 330 may optionally include a memory 370 for storing various data, signals, information, and/or instructions. In some embodiments, the memory 370 may include a non-transitory computer-readable medium, such as a random access memory (RAM), a non-volatile (NV) memory, and so forth. The non-transitory computer-readable medium may store instructions for informing on a homebase, in accordance with aspects of the present disclosure.

In some embodiments, the ambient control module 330 may be operably coupled to, connectable to, or connected to (e.g., via wired and/or wireless connectivity) various sensors, devices, systems, computers, servers, and so forth. For instance, the ambient control module 330 may be operably coupled to, connectable to, or connected to one or more sensor(s) 104, as described with reference to FIG. 1. The ambient control module 330 may also be operably coupled to, connectable to, or connected to a local, cloud, and/or remote device, system, computer, server, and so forth.

In some implementations, the processor(s) 350 may carry out steps for informing a vehicle operator on a homebase, in accordance with aspects of the present disclosure. For instance, in some implementations, the processor(s) 350 may initiate or control acquisition and/or reception of homebase data. To this end, the processor(s) 350 may direct the communication hardware 346 to engage in communication with various systems, devices, hardware, components, and so forth. For example, the processor(s) 350 may direct the communication hardware 346 to retrieve or access data, signals, and information from a data storage location, such as memory 370 described with reference to FIG. 3, or database 224 and/or server 226 described with reference to FIG. 2, or other data storage location associated with a homebase or homebase location. In some implementations, the processor(s) 350 may direct the signal hardware 344 to obtain various data, signals, and information from one or more sensors on a vehicle, such as sensor(s) 104 on the vehicle 10 described with reference to FIG. 1

In some implementations, the processor(s) 350 may generate and/or process various signals, data, and information using data, signals, and/or information received or accessed. For instance, the processor(s) 350 may utilize homebase data to generate, or direct the signal hardware 344 to generate, one or more ambient control signal(s). The ambient control signal(s) may be in any form. For example, the ambient control signal(s) may include one or more intermittent and/or continuous voltage signal, current signal, light signal, and so forth, or a combination thereof. In some implementations, the processor(s) 350 may be in direct communication with the sensory device(s) 342, whereby the processor(s) 350 provide generated ambient control signal(s) directly. In other implementations, the signal hardware 344 is in direct communication with the sensory device(s) 342, whereby the signal hardware 344 provides generated ambient control signal(s) directly, independently and/or at the direction of the processor(s) 350.

In some implementations, the ambient control signal(s) may be assembled to form a sensory pattern indicative of at least one condition at the homebase location, such as a light condition, a temperature condition, a ventilation condition, a scent condition, an emergency condition, a weather condition, a time, and a date, and so forth. For instance, in one non-limiting example, one or more ambient control signal intermittently activating a colored light (e.g., a red light) may be assembled to indicate an emergency at the homebase. In another non-limiting example, various ambient control signals operating, continuously or intermittently, different sensory devices may be assembled to mimic conditions at the homebase. For instance, a sequence or combination of ambient control signals may be generated to operate sensory devices, either concurrently and/or sequentially, in order to match or mimic a configuration at the homebase involving, for example, music, light, temperature, as well as many other possibilities. In yet another non-limiting example, one or more ambient control signal may correspond to a personal message, for example, recorded on a mobile device at the homebase, and contained in homebase data transmitted to the ambient control module 330.

In some implementations, the processor(s) 350 may generate and provide a report. The report may be in any form, and include various data and information, including various visual and/or audio signals, images, graphics, tabulated information, data, instructions (user-readable or machine-readable), graphs, lists, numbers, text, and so forth. For example, the report may indicate a condition at the homebase. The report may be communicated to one or more users by way of display, touchscreen, navigation system, speaker, sensory device, and other outputs on the vehicle, as well as transmitted to various devices, systems, or third parties. For example, the report may be streamed, printed, faxed, emailed, and so forth, as well as communicated using telematics, over-the-air transmission, datalink, and other communication protocols. In some embodiments, the processor(s) 350 may generate and transmit the report in cooperation with various communication hardware 346. The report may be provided in real-time, intermittently, periodically (e.g., hourly, daily, weekly, monthly, and so forth), or any combination thereof. The report may also be saved in a storage medium (e.g., a memory, a database, a server, etc.) for later access or retrieval.

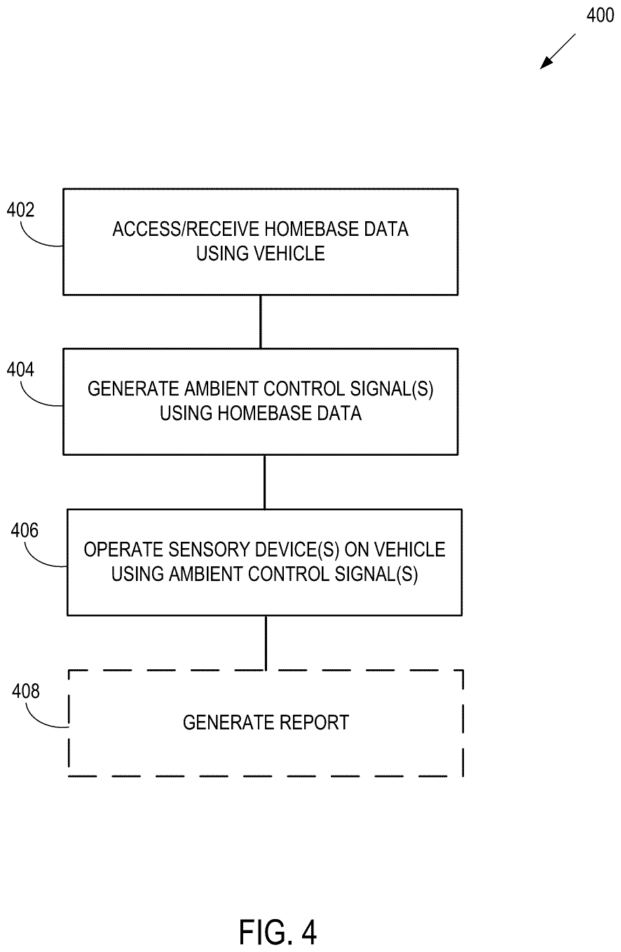

Turning now to FIG. 4, a flowchart setting forth steps of a process 400, in accordance with aspects of the present disclosure, is illustrated. Steps of the process 400 may be carried out using any combination of suitable devices or systems, as well as using systems described in the present disclosure. In some embodiments, steps of the process 400 may be implemented as instructions stored in non-transitory computer readable media, as a program, firmware, or software, and executed by a general-purpose, programmed, or programmable, computer, processor, or any other computing device. In other embodiments, steps of the process 400 may be hardwired in an application-specific computer, processer, or dedicated system or module as described with reference to FIGS. 1 and 3. Although the process 400 is illustrated and described as a sequence of steps, it is contemplated that the steps may be performed in any order or combination. The process 400 need not include all of the illustrated steps, and in some implementations may include other or additional steps.

The process 400 may optionally begin at process block 402 with accessing and/or receiving homebase data associated with a homebase using a vehicle, for instance, as described with reference to FIG. 1. In some implementations, process block 402 may include directing, for example, communication hardware to engage in communication with various systems, devices, hardware, components, and so forth. For example, communication hardware 346 described with reference to FIG. 3 may retrieve or access data, signals, and information from a data storage location, such as memory 370 described with reference to FIG. 3, or database 224 and/or server 226 described with reference to FIG. 2, or any other data storage location associated with a homebase or homebase location. In some implementations, process block 402 may include receiving, either continuously or intermittently, transmission of homebase data acquired at and/or corresponding to a homebase at a homebase location. As described, homebase data may be transmitted in any number of ways and using various hardware, such as by way of a communication system 222 described with reference to FIG. 2.

One or more ambient control signal may then be generated using homebase data received and/or accessed, as indicated by process block 404. For instance, one or more processor 350 described with reference to FIG. 3 may utilize homebase data to generate, or direct a signal hardware 344 to generate, one or more ambient control signal(s). As described, the ambient control signal(s) generated at process block 404 may be in any form. For example, the ambient control signal(s) may include one or more intermittent and/or continuous voltage signal, current signal, light signal, and so forth, or a combination thereof.

In some implementations, the ambient control signal(s) may be assembled at process block 404 to form a sensory pattern indicative of at least one condition at the homebase location, such as a light condition, a temperature condition, a ventilation condition, a scent condition, an emergency condition, a weather condition, a time, and a date, and so forth. For instance, in one non-limiting example, one or more ambient control signal intermittently activating a colored light (e.g., a red light) may be assembled to indicate an emergency at the homebase. In another non-limiting example, various ambient control signals to activate and/or operate, continuously or intermittently, different sensory devices may be assembled to mimic conditions at the homebase. For instance, a sequence or combination of ambient control signals may be generated to activate and/or operate sensory devices, either concurrently and/or sequentially, in order to match or mimic a configuration at the homebase involving, for example, music, light, temperature, as well as many other possibilities. In yet another non-limiting example, one or more ambient control signal may correspond to a personal message, for example, recorded on a mobile device at the homebase, and contained in homebase data transmitted to the ambient control module 330.

Then, at process block 406, one or more sensory device on the vehicle, responsive to the ambient control signal(s), may be operated using the ambient control signal(s). As described, this step may include activating the sensory device(s), modifying a setting in the sensory device(s), and so forth, using the ambient control signal(s). For instance, in some implementations, the ambient control signal(s) may be directed, either directly or indirectly, to the sensory device(s) by a processor(s) 350 and/or signal hardware 344, as described with reference to FIG. 3. In this manner, an environment in or about the vehicle may be modified in accordance with the ambient control signal(s) and/or signal pattern informing a vehicle operator on a homebase. In yet other implementations, a security feature on a mobile device (e.g., of a vehicle operator/occupant) may be modified based on the ambient control signal(s), such as an accessibility, lock screen, and so forth, on the mobile device.

In some implementations, a report may be generated, as indicated by process block 408. As described, the report may be in any form, and include various data and information, including various visual and/or audio signals, images, graphics, tabulated information, data, instructions (user-readable or machine-readable), graphs, lists, numbers, text, and so forth. For example, the report may indicate a condition at the homebase. The report may be communicated to one or more users by way of display, touchscreen, navigation system, speaker, sensory device, and other outputs on the vehicle, as well as transmitted to various devices, systems, or third parties. For example, the report may be streamed, printed, faxed, emailed, and so forth, as well as communicated using telematics, over-the-air transmission, datalink, and other communication protocols. The report may be provided in real-time, intermittently, periodically (e.g., hourly, daily, weekly, monthly, and so forth), or any combination thereof. The report may also be saved in a storage medium (e.g., a memory, a database, a server, etc.) for later access or retrieval.

According to one embodiment, a method informing on a homebase is provided. The method comprising steps of receiving homebase data corresponding to a homebase at a homebase location, wherein the homebase data is transmitted over a communication network to a vehicle at a remote location, generating, using an ambient control module, at least one ambient control signal using the homebase data, and informing a vehicle operator on the homebase by operating at least one sensory device inside the vehicle using the at least one ambient control signal. In one embodiment, the method further comprises acquiring homebase data using at least one device at the homebase location. In another embodiment, the method further comprises accessing homebase data from a server, a database, or a memory associated with the homebase. In yet another embodiment, the method further comprises assembling a plurality ambient control signals to form a sensory pattern indicative of at least one condition at the homebase location. In yet another embodiment, the at least one condition at the homebase location comprises a light condition, a temperature condition, a ventilation condition, a scent condition, an emergency condition, a weather condition, a time, and a date. In yet another embodiment, the method further comprises generating the one or more ambient control signal to correspond to a personal message contained in the homebase data. In yet another embodiment, the method further comprises adapting an environment in the vehicle by modifying a setting in at least one sensory device disposed inside the vehicle using the one or more ambient control signal. In yet another embodiment, the method further comprises modifying a security feature on a mobile device based on the homebase data.

According to another embodiment, a system for informing on a homebase is provided. The system comprises at least one sensory device disposed inside a vehicle, and at least one processor in communication with the at least one sensory device, wherein the at least one processor receives homebase data acquired by at least one device of a homebase at a homebase location, generates one or more ambient control signal using the homebase data, and informs on the homebase by operating at least one sensory device inside the vehicle using the at least one ambient control signal. In one embodiment, the at least one processor further accesses homebase data from a server, database, or data storage location associated with the homebase. In another embodiment, the at least one processor further assembles a plurality ambient control signals to form a sensory pattern indicative of at least one condition at the homebase location. In yet another embodiment, the at least one condition at the homebase location comprises a light condition, a temperature condition, a ventilation condition, a scent condition, an emergency condition, a weather condition, a time, and a date. In yet another embodiment, the at least one processor further generates the one or more ambient control signal to correspond to a personal message contained in the homebase data. In yet another embodiment, the at least one processor further adapts the environment in the vehicle by modifying a setting in the at least one sensory device disposed inside the vehicle using the one or more ambient control signal.

While the present disclosure has described a number of embodiments and implementations, the disclosure is not so limited but covers various obvious modifications and equivalent arrangements, which fall within the purview of the appended claims. Although certain features are expressed in certain combinations among the claims, it is contemplated that these features can be arranged in any combination and order. It should be appreciated that many equivalents, alternatives, variations, and modifications, aside from those expressly stated, are possible.

1. A method informing on a homebase, the method comprising steps of:
receiving homebase data corresponding to a homebase at a homebase location, wherein the homebase data is transmitted over a communication network to a vehicle at a remote location;
generating, using an ambient control module, at least one ambient control signal using the homebase data; and
informing a vehicle operator on the homebase by operating at least one sensory device inside the vehicle using the at least one ambient control signal.

2. The method of claim 1 further comprising acquiring homebase data using at least one device at the homebase location.

3. The method of claim 1 further comprising accessing homebase data from a server, a database, or a memory associated with the homebase.

4. The method of claim 1 further comprising assembling a plurality ambient control signals to form a sensory pattern indicative of at least one condition at the homebase location.

5. The method of claim 4, wherein the at least one condition at the homebase location comprises a light condition, a temperature condition, a ventilation condition, a scent condition, an emergency condition, a weather condition, a time, and a date.

6. The method of claim 1 further comprising generating the one or more ambient control signal to correspond to a personal message contained in the homebase data.

7. The method of claim 1 further comprising adapting an environment in the vehicle by modifying a setting in at least one sensory device disposed inside the vehicle using the one or more ambient control signal.

8. The method of claim 1 further comprising modifying a security feature on a mobile device based on the homebase data.

9. A system for informing on a homebase, the system comprising:
at least one sensory device disposed inside a vehicle; and
at least one processor in communication with the at least one sensory device, wherein the at least one processor:
receives homebase data acquired by at least one device of a homebase at a homebase location;
generates one or more ambient control signal using the homebase data; and
informs on the homebase by operating at least one sensory device inside the vehicle using the at least one ambient control signal.

10. The system of claim 9, wherein the at least one processor further accesses homebase data from a server, database, or data storage location associated with the homebase.

11. The system of claim 9, wherein the at least one processor further assembles a plurality ambient control signals to form a sensory pattern indicative of at least one condition at the homebase location.

12. The system of claim 9, wherein the at least one condition at the homebase location comprises a light condition, a temperature condition, a ventilation condition, a scent condition, an emergency condition, a weather condition, a time, and a date.

13. The system of claim 9, wherein the at least one processor further generates the one or more ambient control signal to correspond to a personal message contained in the homebase data.

14. The system of claim 9, wherein the at least one processor further adapts the environment in the vehicle by modifying a setting in the at least one sensory device disposed inside the vehicle using the one or more ambient control signal.
